(19) United States
(12) Patent Application Publication
(10) Pub. No.: US 2020/0367124 A1
(43) Pub. Date: Nov. 19, 2020

(54) Synchronization Of Client And Access Point During Channel Switch In Wireless Communications

(71) Applicant: MediaTek Singapore Pte. Ltd., Singapore (SG)

(72) Inventors: Vikas Sukhija, Noida (IN); Vinay Garg, Noida (IN); Soumik Das, Noida (IN); Gaurav Sharma, Noida (IN)

(21) Appl. No.: 16/568,231

(22) Filed: Sep. 11, 2019

(30) Foreign Application Priority Data
May 16, 2019 (IN) 201921019461

(51) Int. Cl. H04W 36/06; H04W 68/00; H04W 72/04; H04L 5/00

(52) U.S. Cl. CPC H04W 36/06; H04L 5/0055; H04W 72/0446; H04W 68/005

(57) ABSTRACT

Examples pertaining to synchronization of one or more clients and an access point (AP) during channel switch in wireless communications are described. An apparatus acting as an AP of a wireless network transmits a channel switch announcement (CSA) on a first channel to each of one or more clients in the wireless network. The AP then performs a channel switch from the first channel to a second channel. The AP also determines whether at least a first client of the one or more clients has switched to the second channel by transmitting a unicast frame on the second channel to the first client.

### CROSS REFERENCE TO RELATED PATENT APPLICATION(S)

The present disclosure is part of a non-provisional application claiming the priority benefit of India Patent Application No. 201921019461, filed on 16 May 2019, the content of which being incorporated by reference in its entirety.

### TECHNICAL FIELD

The present disclosure is generally related to wireless communications and, more particularly, to synchronization of clients and access point (AP) during channel switch in wireless communications.

### BACKGROUND

Unless otherwise indicated herein, approaches described in this section are not prior art to the claims listed below and are not admitted as prior art by inclusion in this section.

In a Wi-Fi network that operates in accordance with the Institute of Electrical and Electronics Engineers (IEEE) 802.11H specification, there tends to be an issue when an AP needs to switch an operating channel upon the AP detecting the current channel being inoperable due to poor channel condition(s) (e.g., high noise and/or long channel busy time) or radar detection. That is, per the IEEE 802.11H specification, the AP needs to announce channel switch to its connected clients using Channel Switch Announcement (CSA) and then switch its operating channel after a period of time corresponding to an announced channel switch count. Corresponding, IEEE 802.11H-compliant clients connected to the AP need to switch their operating channel according to the received CSA frame/CSA IE to avoid any need of reconnection. Regarding the switching of the operating channel, the AP stops transmission (Tx) traffic, just before the channel switch, and resumes the Tx traffic after completion of the channel switch.

However, there is an issue in that there is presently no synchronization mechanism between the AP and its connected clients for channel switch completion. For instance, different Wi-Fi devices (including the AP and the connected clients) usually have different channel switching time that may vary from few milliseconds to a few seconds. As the AP has no information on when a client has successfully switched to the new operating channel, or even not switched, this situation could lead to one or more issues. In an event that the AP starts to transmit data for a given client that has not yet switched to the new channel, then packet loss could result. Additionally, in an event that the AP waits too long for a client to complete channel switch (as presently there is no time duration defined for channel switch of client devices), the purpose of saving time during channel switch would be defeated. Besides, such situation could lead to packet drop at the AP end due to its packet storage limit. Moreover, as there could be long wait time for clients to complete channel switch, high latency on the AP side for data packets buffered for clients could result. Furthermore, in an event that a client has not switched to the new channel while the AP starts transmitting data, the client would not reply with an acknowledgement (ACK) and, hence, the AP would unnecessarily attempt one or more retransmissions. Undesirably, this would impact the overall medium efficiency.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure aims to provide schemes, solutions, concepts, designs, methods and systems pertaining to synchronization of one or more clients and an AP during channel switch in wireless communications. In particular, the present disclosure aims to provide a synchronization mechanism for channel switch, thereby avoiding or otherwise alleviating aforementioned issues. It is noteworthy that the proposed schemes, solutions, concepts, designs, methods and systems described herein apply to multiple clients and not just a particular client. Therefore, the scope of the proposed schemes, solutions, concepts, designs, methods and systems is not limited to one client or any particular client even though description below of various examples may refer to a “first client” for illustrative purposes.

In one aspect, a method may involve a processor of an apparatus, acting as an access point (AP) in a wireless network, transmitting a channel switch announcement (CSA) on a first channel to each of one or more clients in the wireless network. The method may also involve the processor performing a channel switch from the first channel to a second channel. The method may further involve the processor determining whether at least a first client (or any other client) of the one or more clients has switched to the second channel by transmitting a unicast frame on the second channel to the first client.

In another aspect, a method may involve a processor of an apparatus, acting as a client in a wireless network associated with an AP, receiving a CSA on a first channel from the AP. The method may also involve the processor performing a channel switch from the first channel to a second channel responsive to receiving the CSA. The method may further involve the processor receiving a unicast frame on the second channel from the AP.

In yet another aspect, an apparatus may include a transceiver and a processor coupled to the transceiver. The transceiver may be configured to wirelessly transmit and receive data and information. The processor may be configured to: (i) transmit, via the transceiver with the apparatus acting as an AP in a wireless network, a CSA on a first channel to each of one or more clients in the wireless network; (ii) perform, via the transceiver, a channel switch from the first channel to a second channel; and (iii) determine whether at least a first client (or any other client) of the one or more clients has switched to the second channel by transmitting, via the transceiver, a unicast frame on the second channel to the first client.

It is noteworthy that, although description provided herein may be in the context of certain radio access technologies, networks and network topologies such as Wi-Fi in accordance with the IEEE 802.11 specifications, the proposed concepts, schemes and any variation(s)/derivative(s) thereof may be implemented in, for and by other types of radio access technologies, networks and network topologies such as, for example and without limitation, 5^{th} Generation (5G), New Radio (NR), Long-Term Evolution (LTE), LTE-Advanced, and LTE-Advanced Pro. That is, description herein with respect to an AP may be applicable to a base station (e.g., gNB or eNB) of a mobile network (e.g., a 5G/NR network or an LTE network) and description herein with respect to a client may be applicable to a user equipment (UE) of the mobile network. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in which a proposed scheme in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

FIG. 5 is a diagram of an example scenario of channel switch under a conventional approach.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to synchronization of one or more clients and an AP during channel switch in wireless communications. According to the present disclosure, a number of possible solutions may be implemented separately or jointly. That is, although these possible solutions may be described below separately, two or more of these possible solutions may be implemented in one combination or another.

Under a proposed scheme in accordance with the present disclosure, after channel switch from an original channel to a new channel, an AP may transmit on the new channel a respective unicast frame (which may be a null frame, a data frame, a management frame or an action frame) to each of a plurality of clients that are connected to the AP. The AP may wait for a respective ACK frame from each of the connected clients before resuming transmission of data for the clients. In an event that the AP does not receive ACK from a given client, the AP may periodically transmit the respective unicast frame to that client until an ACK is received from that client. Under the proposed scheme, after channel switch and upon receiving a respective unicast frame from the AP on the new channel, each client may respond with a respective ACK frame to indicate to the AP receipt of the respective unicast frame on the new channel. The AP may resume transmission of data as soon as the AP receives ACK from any client on the new channel. Meanwhile, the AP may continue to periodically transmit a respective unicast frame to each of the remaining clients that have not yet responded with an ACK on the new channel.

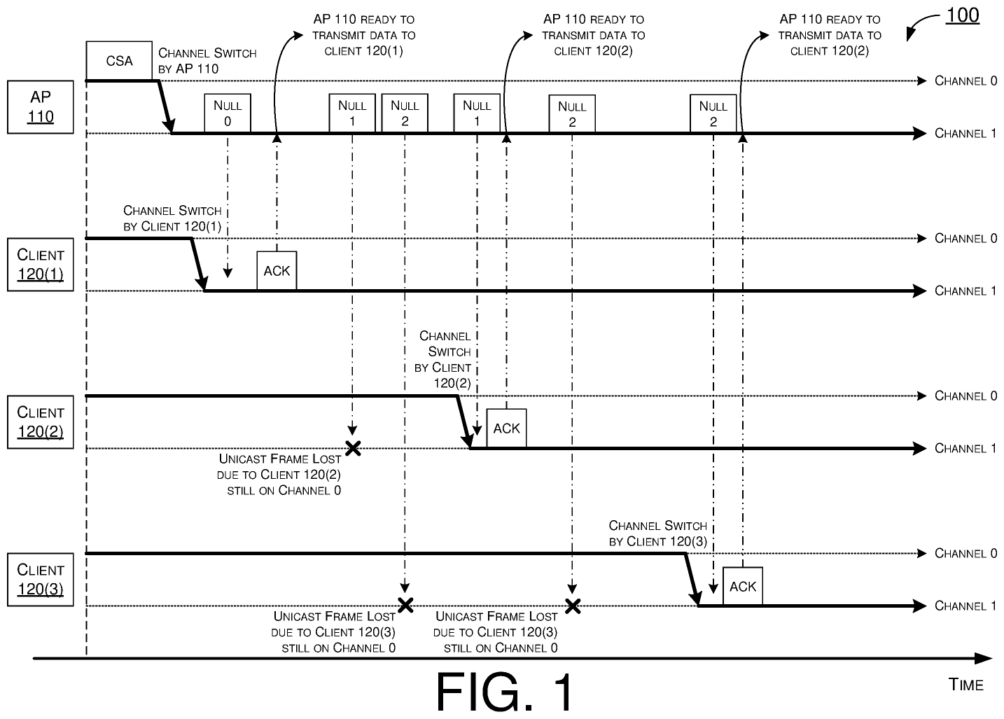

FIG. 1 illustrates an example scenario 100 in which a proposed scheme in accordance with the present disclosure may be implemented. Scenario 100 may involve an AP 110 of a wireless network 105 (e.g., a basic service set (BSS) or a cell) and a plurality of connected clients 120(1)˜120(N) in the wireless network with N being a positive integer greater than 1. For simplicity, N=3 in the example shown in FIG. 1 although proposed schemes in accordance with the present disclosure may be implemented in different scenarios with different number of clients.

In scenario 100, client 120(1), client 120(2) and client 120(3) are client devices or stations that are connected to AP 110, and clients 120(1)˜120(3) all have different channel switch times. That is, it may take client 120(1) an amount of time X to switch an operating channel from a first channel (denoted as “channel 0” in FIG. 1) to a second channel (denoted as “channel 1” in FIG. 1), it may take client 120(2) an amount of time Y to switch an operating channel from the first channel to the second channel, and it may take client 120(2) an amount of time Z to switch an operating channel from the first channel to the second channel, where X≠Y≠Z. In scenario 100, the first channel is the original channel as the operating channel on which AP 110 and clients 120(1)˜120(N) wirelessly transmit and receive frames/packets/data, respectively, and the second channel is the new channel to which AP 110 and clients 120(1)˜120(N) are to switch.

Under the proposed scheme in accordance with the present disclosure, during the channel switch procedure (e.g., upon AP 110 transmitting a CSA frame or CSA information element (IE) to clients 120(1)˜120(N)), AP 110 starts transmitting a respective unicast frame to each of clients 120(1)˜120(N). Each unicast frame may be a null frame, a data frame, a management frame or an action frame. In scenario 100, client 120(0) may switch from the first channel to the second channel soon after AP 110 switches to the second channel and transmits to client 120(1) on the second channel a unicast frame which is specific for client 120(1) (denoted as “null 0” in FIG. 1). In response to receiving the respective unicast frame, client 120(1) may reply by transmitting on the second channel an acknowledgement (ACK) to AP 110 to indicate receipt of the respective unicast frame. Accordingly, AP 110 may start to transmit on the second channel data packets, if any, that are destined for client 120(1) and buffered at AP 110.

Similarly, AP 110 may transmit on the second channel a respective unicast frame to each of client 120(2) and client 120(3) (denoted as “null 1” and “null 2” in FIG. 1, respectively). However, as each of client 120(2) and client 120(3) takes longer time to switch channel, each of client 120(2) and client 120(3) may miss the respective unicast frames on the second channel for one or more times. That is, the respective unicast frame may be lost due to each of client 120(2) and client 120(3) still being on the first channel and not yet transferred to the second channel. Under the proposed scheme, when AP 110 does not receive an ACK from a given client after AP 110 transmits a respective unicast frame on the second channel to that client, AP 110 may periodically transmit the respectively unicast frame on the second channel to that client until an ACK is received from that client on the second channel. Thus, for each of client 120(2) and client 120(3), AP 110 may continue to periodically transmit the respective unicast frame on the second channel until a respective ACK is received from each of client 120(2) and client 120(3) on the second channel. Once AP 110 receives a respective ACK from each of client 120(2) and client 120(3), AP 110 may start to transmit on the second channel data packets, if any, that are destined for client 120(2) or client 120(3) and buffered at AP 110.

Advantageously, the proposed scheme may solve the issue of synchronization with unicast frame/ACK interaction between an AP and its connected clients. It is believed that those with ordinary skill in the art would appreciate that, under the proposed scheme, there would be zero information loss due to client unavailability on the new channel, since traffic of data transmission is only resumed after a client responds to the AP on the new channel. Moreover, the proposed synchronization mechanism provides time efficiency as traffic of data transmission starts as soon as a client responds on the new channel. Under the proposed scheme, there would be no dependency on different channel switching times of different clients, as respective traffic of data transmission for each client would start after that client transmits an ACK to the AP while the AP waits for acknowledgement on the new channel from other client(s) that take extra time to perform the channel switch.

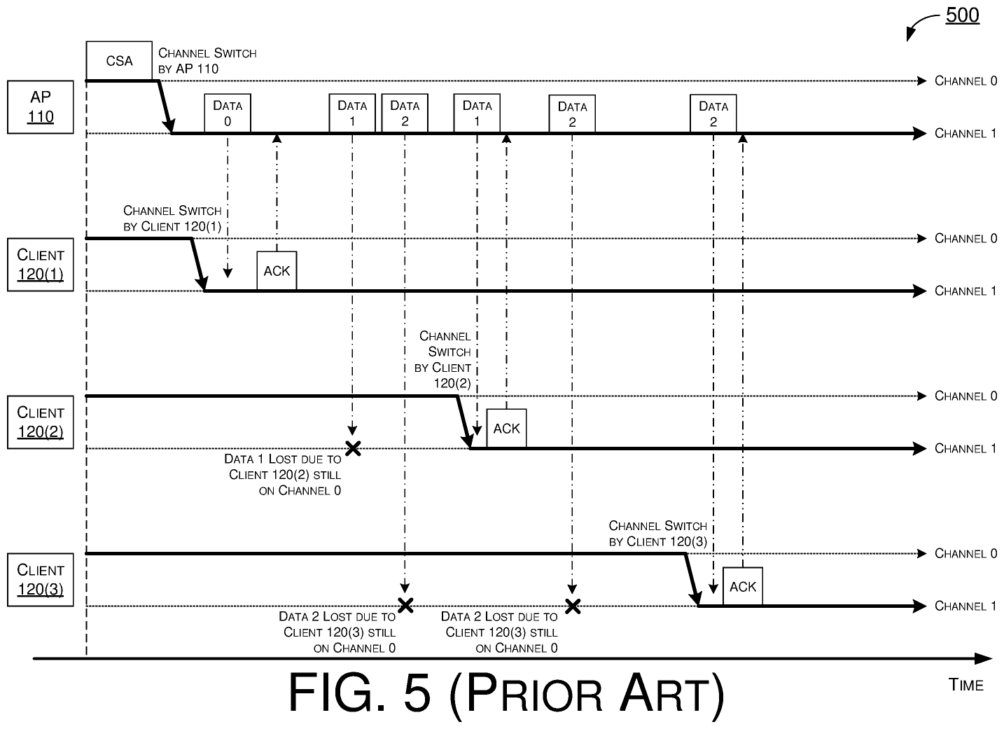

To aid better appreciation of the advantages and benefits provided by the proposed scheme, as comparison, an example scenario 500 of channel switch under a conventional approach is shown in FIG. 5. For simplicity, scenario 500 is shown to also involve AP 110 and clients 120(1)˜120(3).

In scenario 500, client 120(1), client 120(2) and client 120(3) are client devices or stations that are connected to AP 110, and clients 120(1)˜120(3) all have different channel switch times. That is, it may take client 120(1) an amount of time X to switch an operating channel from a first channel (denoted as “channel 0” in FIG. 5) to a second channel (denoted as “channel 1” in FIG. 5), it may take client 120(2) an amount of time Y to switch an operating channel from the first channel to the second channel, and it may take client 120(2) an amount of time Z to switch an operating channel from the first channel to the second channel, where X≠Y≠Z. In scenario 500, the first channel is the original channel as the operating channel on which AP 110 and clients 120(1)˜120(N) wirelessly transmit and receive frames/packets/data, respectively, and the second channel is the new channel to which AP 110 and clients 120(1)˜120(N) are to switch.

During the channel switch procedure (e.g., upon AP 110 transmitting a CSA to clients 120(1)˜120(N)), AP 110 starts transmitting respective data (e.g., data packet(s)/frame(s)) to each of clients 120(1)˜120(3) (denoted as “data 0”, “data 1” and “data 2” in FIG. 5, respectively). In scenario 500, client 120(0) switches from the first channel to the second channel soon after AP 110 switches to the second channel and transmits to client 120(1) on the second channel respective data which is specific for client 120(1) (denoted as “data 0” in FIG. 5). In response to receiving the respective unicast frame, client 120(1) replies by transmitting on the second channel an ACK to AP 110 to indicate receipt of the respective data.

Similarly, AP 110 transmits on the second channel respective data to each of client 120(2) and client 120(3). However, as each of client 120(2) and client 120(3) takes longer time to switch channel, each of client 120(2) and client 120(3) misses the respective data on the second channel for one or more times. That is, the respective data packet(s)/frame(s) are lost due to each of client 120(2) and client 120(3) still being on the first channel and not yet transferred to the second channel. Under the conventional approach, AP 110 would continue to periodically transmit respective data to each of client 120(2) and client (3) even when AP 110 has not yet received an ACK from each of client 120(2) and client 120(3) on the second channel. That is, under the conventional approach, AP 110 would continue retries by transmitting respective data packet(s)/frame(s) to each of client 120(2) and client 120(3) even though they have not switched to the new channel. As can be seen, this would undesirably result in inefficiency in usage of the medium, which is avoided with the proposed scheme in accordance with the present disclosure.

### Illustrative Implementations

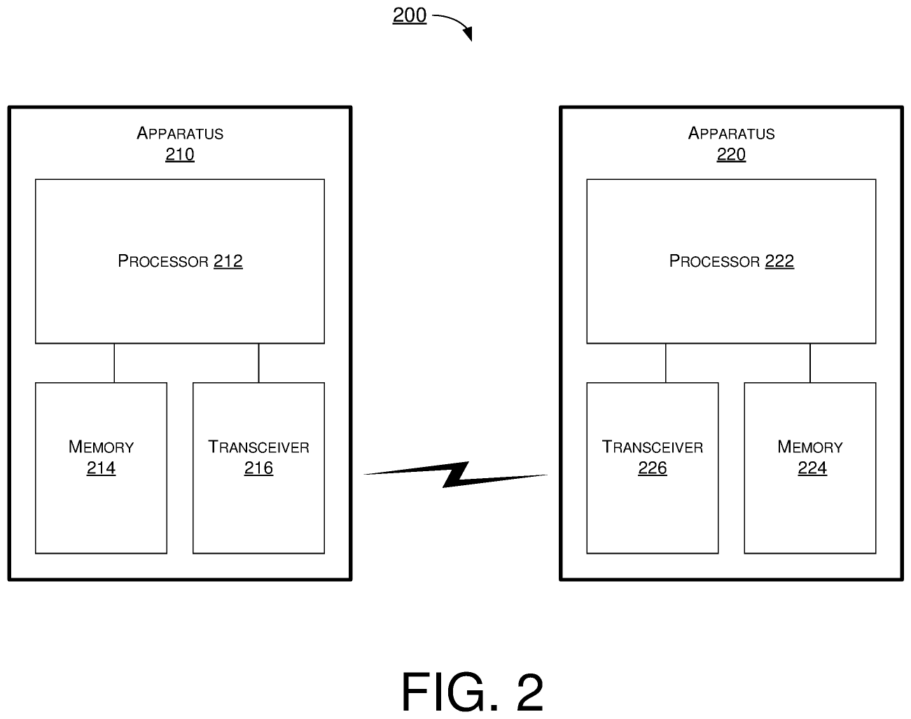

FIG. 2 illustrates an example communication environment 200 having an example apparatus 210 and an example apparatus 220 in accordance with an implementation of the present disclosure. Each of apparatus 210 and apparatus 220 may perform various functions to implement schemes, techniques, processes and methods described herein pertaining to synchronization of one or more clients and an AP during channel switch in wireless communications, including various schemes described above as well as processes 300 and 400 described below.

Each of apparatus 210 and apparatus 220 may be a part of an electronic apparatus, which may be a portable or mobile apparatus, a wearable apparatus, a wireless communication apparatus or a computing apparatus. For instance, each of apparatus 210 and apparatus 220 may be implemented in an access point (AP), a repeater, a smartphone, a smartwatch, a personal digital assistant, a digital camera, or a computing equipment such as a tablet computer, a laptop computer or a notebook computer. Each of apparatus 210 and apparatus 220 may also be a part of a machine type apparatus, which may be an IoT or NB-IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. Alternatively, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. Each of apparatus 210 and apparatus 220 may include at least some of those components shown in FIG. 2 such as a processor 212 and a processor 222, respectively. Each of apparatus 210 and apparatus 220 may further include one or more other components not pertinent to the proposed scheme of the present disclosure (e.g., internal power supply, display device and/or user interface device), and, thus, such component(s) of each of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including implementation of synchronization of one or more clients and an AP during channel switch in wireless communications in accordance with various implementations of the present disclosure.

In some implementations, apparatus 210 may also include a transceiver 216 as a communication device coupled to processor 212 and configured to wirelessly transmit and receive data. In some implementations, apparatus 210 may further include a memory 214 coupled to processor 212 and capable of being accessed by processor 212 and storing data therein. In some implementations, apparatus 220 may also include a transceiver 226 as a communication device coupled to processor 222 and configured to wirelessly transmit and receive data. In some implementations, apparatus 220 may further include a memory 224 coupled to processor 222 and capable of being accessed by processor 222 and storing data therein. Accordingly, apparatus 210 and apparatus 220 may wirelessly communicate with each other via transceiver 216 and transceiver 226, respectively.

To aid better understanding, the following description of the operations, functionalities and capabilities of each of apparatus 210 and apparatus 220 is provided in the context of apparatus 210 acting as an AP (e.g., AP 110) and apparatus 220 acting as a connected client (e.g., any of clients 120(1)˜120(N)) of a wireless network (e.g., wireless network 105). It is noteworthy that, under the proposed schemes in accordance with the present disclosure, apparatus 410 may act as an AP as well as a client (e.g., as a repeater having an AP interface and a client/station (STA) interface or, alternatively, as a wireless device that acts as an AP relative to one or more other wireless devices and as a client relative to another AP). Similarly, apparatus 420 may act as an AP as well as a client (e.g., as a repeater having an AP interface and a client/STA interface or, alternatively, as a wireless device that acts as an AP relative to one or more other wireless devices and as a client relative to another AP). Thus, description herein with respect to the capabilities of apparatus 410 is applicable to apparatus 420, and vice versa.

In one aspect of synchronization of one or more clients and an AP during channel switch in wireless communications, processor 212 of apparatus 210 acting as an AP in a wireless network may transmit, via transceiver 216, a channel switch announcement (CSA) on a first channel to each of one or more clients in the wireless network. In some implementations, in transmitting the CSA, processor 212 may transmit a CSA frame. Alternatively, in transmitting the CSA, processor 212 may transmit a CSA information element (IE). Moreover, processor 212 may perform, via transceiver 216, a channel switch from the first channel to a second channel. Furthermore, processor 212 may determine whether at least a first client (or any other client) of the one or more clients has switched to the second channel by transmitting, via transceiver 216, a unicast frame on the second channel to the first client. Additionally, processor 212 may receive, via transceiver 216, an acknowledgement (ACK) from the first client. In response to receiving the ACK, processor 212 may transmit, via transceiver 216, one or more data packets to the first client.

In some implementations, the unicast frame may include a null frame. Alternatively, or additionally, the unicast frame may include a data frame. Alternatively, or additionally, the unicast frame may include a management frame. Alternatively, or additionally, the unicast frame may include an action frame.

In some implementations, in receiving the ACK from the first client, processor 212 may receive the ACK after transmitting the unicast frame on the second channel to the first client periodically for multiple times.

In some implementations, in determining whether at least a first client of the one or more clients has switched to the second channel, processor 212 may transmit, via transceiver 216, the unicast frame on the second channel to the first client and a second client. Additionally, in receiving the ACK from the first client, processor 212 may not receive one other ACK from the second client. Moreover, in transmitting the one or more data packets to the first client, processor 212 may transmit, via transceiver 216, the unicast frame on the second channel to the second client periodically until the other ACK is received from the second client.

In another aspect of synchronization of one or more clients and an AP during channel switch in wireless communications, processor 222 of apparatus 220 acting as a client in a wireless network associated with an AP (e.g., apparatus 410) may receive, via transceiver 226, a CSA on a first channel from the AP. In some implementations, in receiving the CSA, processor 222 may receive a CSA frame. Alternatively, in receiving the CSA, processor 222 may receive a CSA information element (IE). Moreover, processor 222 may perform, via transceiver 226, a channel switch from the first channel to a second channel responsive to receiving the CSA. Furthermore, processor 222 may receive, via transceiver 226, a unicast frame on the second channel from the AP. Additionally, processor 222 may transmit, via transceiver 226, an acknowledgement (ACK) to the AP responsive to receiving the unicast frame. In response to transmitting the ACK, processor 222 may receive, via transceiver 226, one or more data packets destined for the client from the AP.

In some implementations, the unicast frame may include a null frame. Alternatively, or additionally, the unicast frame may include a data frame. Alternatively, or additionally, the unicast frame may include a management frame. Alternatively, or additionally, the unicast frame may include an action frame.

### Illustrative Processes

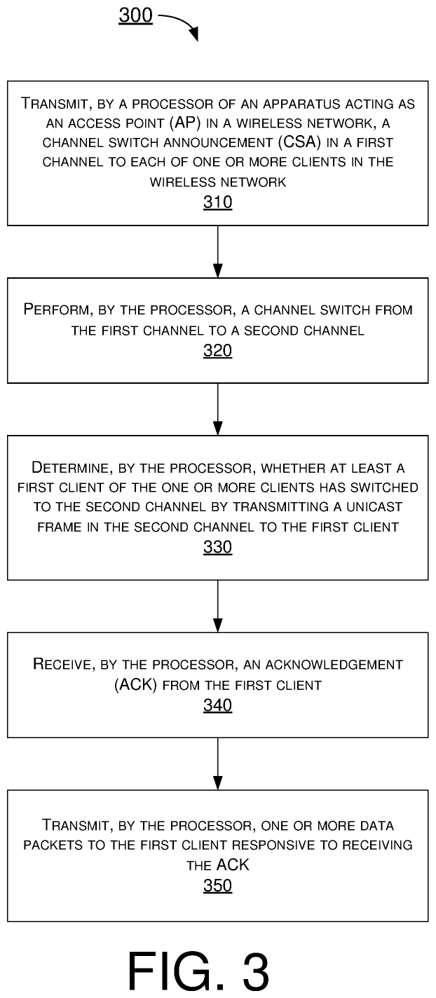

FIG. 3 illustrates an example process 300 in accordance with an implementation of the present disclosure. Process 300 may be an example implementation of the proposed schemes described above with respect to synchronization of one or more clients and an AP during channel switch in wireless communications in accordance with the present disclosure. Process 300 may represent an aspect of implementation of features of apparatus 210 and apparatus 220. Process 300 may include one or more operations, actions, or functions as illustrated by one or more of blocks 310, 320, 330, 340 and 350. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may also be repeated partially or entirely. Process 300 may be implemented by apparatus 210, apparatus 220 and/or any suitable wireless communication device, UE, base station or machine type devices. Solely for illustrative purposes and without limitation, process 300 is described below in the context of apparatus 210 acting as an AP (e.g., AP 110) and apparatus 220 acting as a connected client (e.g., any of clients 120(1)˜120(N)) of a wireless network (e.g., wireless network 105). Process 300 may begin at block 310.

At 310, process 300 may involve processor 212 of apparatus 210 acting as an AP in a wireless network transmitting, via transceiver 216, a channel switch announcement (CSA) on a first channel to each of one or more clients in the wireless network. In some implementations, in transmitting the CSA, process 300 may involve processor 212 transmitting a CSA frame. Alternatively, in transmitting the CSA, process 300 may involve processor 212 transmitting a CSA information element (IE). Process 300 may proceed from 310 to 320.

At 320, process 300 may involve processor 212 performing, via transceiver 216, a channel switch from the first channel to a second channel. Process 300 may proceed from 320 to 330.

At 330, process 300 may involve processor 212 determining whether at least a first client (or any other client) of the one or more clients has switched to the second channel by transmitting, via transceiver 216, a unicast frame on the second channel to the first client. Process 300 may proceed from 330 to 340.

At 340, process 300 may involve processor 212 receiving, via transceiver 216, an acknowledgement (ACK) from the first client. Process 300 may proceed from 340 to 350.

At 350, process 300 may involve processor 212 transmitting, via transceiver 216, one or more data packets to the first client responsive to receiving the ACK.

In some implementations, the unicast frame may include a null frame. Alternatively, or additionally, the unicast frame may include a data frame. Alternatively, or additionally, the unicast frame may include a management frame. Alternatively, or additionally, the unicast frame may include an action frame.

In some implementations, in receiving the ACK from the first client, process 300 may involve processor 212 receiving the ACK after transmitting the unicast frame on the second channel to the first client periodically for multiple times.

In some implementations, in determining whether at least a first client of the one or more clients has switched to the second channel, process 300 may involve processor 212 transmitting, via transceiver 216, the unicast frame on the second channel to the first client and a second client. Additionally, in receiving the ACK from the first client, process 300 may involve processor 212 not receiving one other ACK from the second client. Moreover, in transmitting the one or more data packets to the first client, process 300 may involve processor 212 transmitting, via transceiver 216, the unicast frame on the second channel to the second client periodically until the other ACK is received from the second client.

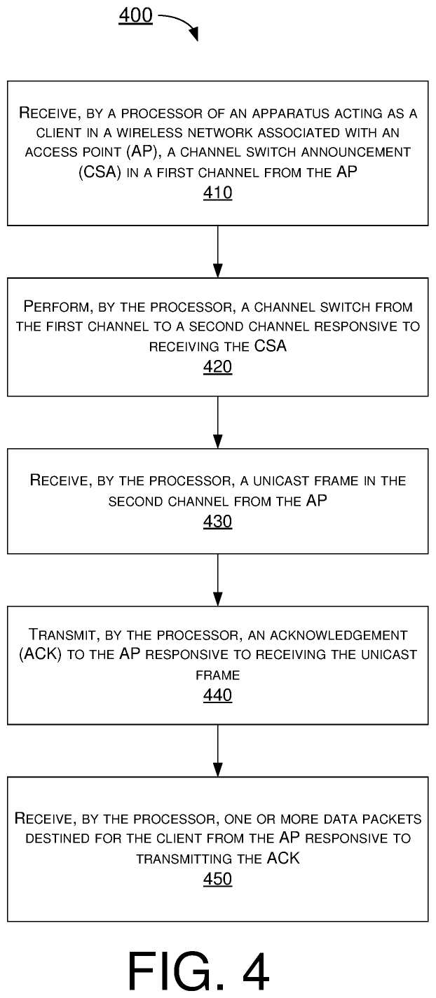

FIG. 4 illustrates an example process 400 in accordance with an implementation of the present disclosure. Process 400 may be an example implementation of the proposed schemes described above with respect to synchronization of one or more clients and an AP during channel switch in wireless communications in accordance with the present disclosure. Process 400 may represent an aspect of implementation of features of apparatus 210 and apparatus 220. Process 400 may include one or more operations, actions, or functions as illustrated by one or more of blocks 410, 420, 430, 440 and 450. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may also be repeated partially or entirely. Process 400 may be implemented by apparatus 210, apparatus 220 and/or any suitable wireless communication device, UE, base station or machine type devices. Solely for illustrative purposes and without limitation, process 400 is described below in the context of apparatus 210 acting as an AP (e.g., AP 110) and apparatus 220 acting as a connected client (e.g., any of clients 120(1)˜120(N)) of a wireless network (e.g., wireless network 105). Process 400 may begin at block 410.

At 410, process 400 may involve processor 222 of apparatus 220 acting as a client in a wireless network associated with an AP receiving, via transceiver 226, a channel switch announcement (CSA) on a first channel from the AP. In some implementations, in receiving the CSA, process 400 may involve processor 222 receiving a CSA frame. Alternatively, in receiving the CSA, process 400 may involve processor 222 receiving a CSA information element (IE). Process 400 may proceed from 410 to 420.

At 420, process 400 may involve processor 222 performing, via transceiver 226, a channel switch from the first channel to a second channel responsive to receiving the CSA. Process 400 may proceed from 420 to 430.

At 430, process 400 may involve processor 222 receiving, via transceiver 226, a unicast frame on the second channel from the AP. Process 400 may proceed from 430 to 440.

At 440, process 400 may involve processor 222 transmitting, via transceiver 226, an acknowledgement (ACK) to the AP responsive to receiving the unicast frame. Process 400 may proceed from 440 to 450.

At 450, process 400 may involve processor 222 receiving, via transceiver 226, one or more data packets destined for the client from the AP responsive to transmitting the ACK.

In some implementations, the unicast frame may include a null frame. Alternatively, or additionally, the unicast frame may include a data frame. Alternatively, or additionally, the unicast frame may include a management frame. Alternatively, or additionally, the unicast frame may include an action frame.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus acting as an access point (AP) in a wireless network, a channel switch announcement (CSA) on a first channel to each of one or more clients in the wireless network;
performing, by the processor, a channel switch from the first channel to a second channel; and
determining, by the processor, whether at least a first client of the one or more clients has switched to the second channel by transmitting a unicast frame on the second channel to the first client.

2. The method of claim 1, wherein the unicast frame comprises a null frame.

3. The method of claim 1, wherein the unicast frame comprises a data frame, a management frame or an action frame.

4. The method of claim 1, wherein the transmitting of the CSA comprises transmitting a CSA frame or a CSA information element (IE).

5. The method of claim 1, further comprising:
receiving, by the processor, an acknowledgement (ACK) from the first client; and
transmitting, by the processor, one or more data packets to the first client responsive to receiving the ACK.

6. The method of claim 5, wherein the receiving of the ACK from the first client comprises receiving the ACK after transmitting the unicast frame on the second channel to the first client periodically for multiple times.

7. The method of claim 5, wherein the determining of whether at least a first client of the one or more clients has switched to the second channel comprises transmitting the unicast frame on the second channel to the first client and a second client, wherein the receiving of the ACK from the first client comprises not receiving one other ACK from the second client, and wherein the transmitting of the one or more data packets to the first client comprises transmitting the unicast frame on the second channel to the second client periodically until the other ACK is received from the second client.

8. A method, comprising:
receiving, by a processor of an apparatus acting as a client in a wireless network associated with an access point (AP), a channel switch announcement (CSA) on a first channel from the AP;
performing, by the processor, a channel switch from the first channel to a second channel responsive to receiving the CSA; and
receiving, by the processor, a unicast frame on the second channel from the AP.

9. The method of claim 8, wherein the unicast frame comprises a null frame.

10. The method of claim 8, wherein the unicast frame comprises a data frame, a management frame or an action frame.

11. The method of claim 8, wherein the receiving of the CSA comprises receiving a CSA frame or a CSA information element (IE).

12. The method of claim 8, further comprising:
transmitting, by the processor, an acknowledgement (ACK) to the AP responsive to receiving the unicast frame; and
receiving, by the processor, one or more data packets destined for the client from the AP responsive to transmitting the ACK.

13. An apparatus, comprising:
a transceiver configured to wirelessly transmit and receive data and information; and
a processor coupled to the communication device and configured to perform operations comprising:
transmitting, via the transceiver with the apparatus acting as an access point (AP) in a wireless network, a channel switch announcement (CSA) on a first channel to each of one or more clients in the wireless network;
performing, via the transceiver, a channel switch from the first channel to a second channel; and
determining whether at least a first client of the one or more clients has switched to the second channel by transmitting, via the transceiver, a unicast frame on the second channel to the first client.

14. The apparatus of claim 13, wherein the unicast frame comprises a null frame.

15. The apparatus of claim 13, wherein the unicast frame comprises a data frame, a management frame or an action frame.

16. The apparatus of claim 13, wherein, in transmitting the CSA, the processor is configured to transmit a CSA frame or a CSA information element (IE).

17. The apparatus of claim 13, wherein, with the apparatus acting as the AP in the wireless network, the processor is further configured to perform operations comprising:
receiving, via the transceiver, an acknowledgement (ACK) from the first client; and
transmitting, via the transceiver, one or more data packets to the first client responsive to receiving the ACK.

18. The apparatus of claim 17, wherein, in receiving the ACK from the first client, the processor is configured to receive the ACK after transmitting the unicast frame on the second channel to the first client periodically for multiple times.

19. The apparatus of claim 17, wherein, in determining whether at least a first client of the one or more clients has switched to the second channel, the processor is configured to transmit, via the transceiver, the unicast frame on the second channel to the first client and a second client, wherein, in receiving the ACK from the first client, the processor is configured to not receive one other ACK from the second client, and wherein, in transmitting the one or more data packets to the first client, comprises the processor is configured to transmit, via the transceiver, the unicast frame on the second channel to the second client periodically until the other ACK is received from the second client.

20. The apparatus of claim 13, wherein, with the apparatus acting as a client in the wireless network, the processor is configured to perform operations comprising:
receiving, via the transceiver, a second CSA in a third channel from a second AP;
performing, via the transceiver, a channel switch from the third channel to a fourth channel responsive to receiving the CSA from the second AP;
receiving, via the transceiver, a second unicast frame in the fourth channel from the second AP;
transmitting, via the transceiver, an acknowledgement (ACK) to the second AP responsive to receiving the second unicast frame; and
receiving, via the transceiver, one or more data packets from the second AP responsive to transmitting the ACK.
